(19) United States
(12) Patent Application Publication
(10) Pub. No.: US 2010/0201693 A1
(43) Pub. Date: Aug. 12, 2010

(54) SYSTEM AND METHOD FOR AUDIENCE PARTICIPATION EVENT WITH DIGITAL AVATARS

(75) Inventors: Patricia L. Caplette, Diamond Bar, CA (US); Elizabeth F. Stephanoff, Lawndale, CA (US); Billy L. Almon, Washington, DC (US)

Correspondence Address: DISNEY ENTERPRISES, INC.;C/O KNOBBE, MARTENS, OLSON & BEAR, LLP, 2040 MAIN STREET, 14TH FLOOR, IRVINE, CA, 92614, US

(73) Assignee: Disney Enterprises, Inc., Burbank, CA (US)

(21) Appl. No.: 12/369,644

(22) Filed: Feb. 11, 2009

(51) Int. Cl. G06T 15/70

(52) U.S. Cl. 345/474

(57) ABSTRACT

A system and method for capturing the voice and motion of a user and mapping the captured voice and motion to an avatar is disclosed. Other aspects include displaying the avatar in the virtual world of a movie or animation chosen by the user.

### BACKGROUND OF THE INVENTION

1. Field of the Invention

This disclosure relates generally to mapping both the voice and body movements of a user's performance to an avatar in an electronic system, the electronic system sometimes being referred to as a virtual world.

2. Description of the Related Technology

A virtual world is a simulated environment in which users may interact with each other via one or more computer processors. Users may appear on a video screen in the form of representations referred to as avatars. The degree of interaction between the avatar and the simulated environment is implemented by one or more computer applications that govern such interactions as simulated physics, exchange of information between users, and the like. The nature of interactions among users of the virtual world is often limited by the constraints of the system implementing the virtual world.

An avatar is a computerized graphical manifestation of a character in an electronic system. An avatar serves as a visual representation of an entity that other users can interact within a computer network. Often used in video games, a participant is represented to his or her in-game counterpart in the form of a previously created and stored avatar image. Avatars are often used in the gaming industry, both on consumer game consoles, personal computers and in arcades.

As computing power has expanded, developers of video games have likewise created game software that takes advantage of increases in computing power. As game complexity continues to intrigue players, game and hardware manufacturers have continued to innovate to enable additional interactivity and computer programs to move beyond games and to movies, videos and other forms of entertainment.

### SUMMARY OF CERTAIN INVENTIVE ASPECTS

The system and method of the disclosure each have several aspects, no single one of which is solely responsible for its desirable attributes. Without limiting the scope of this disclosure as expressed by the claims which follow, its more prominent features will now be discussed briefly. After considering this discussion, and particularly after reading the section entitled “Detailed Description of Certain Embodiments”, one will understand how the features of this disclosure provide advantages that include a system and method for creating an avatar, mapping an avatar to the voice and movements of a user in a virtual space and outputting the avatar performance into a visual display.

One embodiment includes a method for creating and controlling an avatar in a virtual space, the virtual space accessed through a computer network executing a computer program. The method includes identifying an animation or movie from a predetermined list, identifying a song or scene from the movie or animation, creating an avatar, capturing a user's live voice recording in a data storage, capturing the user's live movements to the data storage, translating the captured movements to a particular format, mapping the user's movements to the avatar, mapping the user's corresponding recorded voice recording to correspond with the animated avatar, and displaying the animated avatar with sound where the capturing, processing and mapping are continuously performed so as correlate the movements of the user to the displayed avatar. In some embodiments creating the avatar includes selecting a character from the animation or movie, creating a digital representation of the user, or selecting a predefined avatar and altering the features of the avatar according to user input.

In yet another embodiment, the method for creating and controlling an avatar in a virtual space further includes displaying the avatar on either a television, a digital keepsake, a movie screen, or the Internet.

Another embodiment includes a method for creating and controlling an avatar in a virtual space where mapping the user's movements to the avatar is done proportional in acceleration and deceleration to the rotational and translational movements of the user. The portions of the avatar include specific animated body parts. In some embodiments, the list of avatars is representative to the selected movie or animation and the avatar is animated in a virtual space where the virtual space includes scenes from a movie or animation.

Yet another embodiment includes a method for user interaction with animated characters where outputting the avatar's movement and voice includes displaying the avatars of all of the users in a performance, displaying at least one performance where the displaying can take place over a period of time and can be remote from the live performance such that users in different locations can view performances and vote on their favorites.

Still another embodiment includes a method for interactively controlling the voice and motions of at least one avatar through a computer network. The method includes capturing input including the movements of the at least one user; and the voice of the at least one user. The method further includes processing the input where processing the input includes mapping the voice and movement of the at least one user to the animated motion of the corresponding avatar, and where the capturing, processing and mapping are continuously performed so as to correlate between relative motion of the at least one user and the corresponding avatar.

### BRIEF DESCRIPTION OF THE DRAWINGS

FIG. 1 is a block diagram illustrating the components and data flow of an embodiment of an avatar mapping system.

FIG. 2 illustrates a group of system users engaged in a performance.

FIG. 3 illustrates an avatar representation of the users in FIG. 2 after being recorded and mapped onto the user-chosen avatars.

FIG. 4 is a flowchart illustrating an example of a method for mapping a user's voice and motions onto an avatar.

FIG. 5 is a higher level flowchart of the avatar mapping system.

FIG. 6 is an operational flowchart of the process for creating an avatar.

FIG. 7A is a block diagram illustrating an exemplary system for avatar mapping.

FIG. 7B is a block diagram illustrating a section of the exemplary system for avatar mapping of FIG. 7A.

FIG. 7C is a diagram illustrating a section of the exemplary system for avatar mapping of FIG. 7A.

### DETAILED DESCRIPTION OF CERTAIN INVENTIVE EMBODIMENTS

The following detailed description is directed to certain specific embodiments of the invention. However, the invention can be embodied in a multitude of different ways as defined and covered by the claims. In this description, reference is made to the drawings wherein like parts are designated with like numerals throughout.

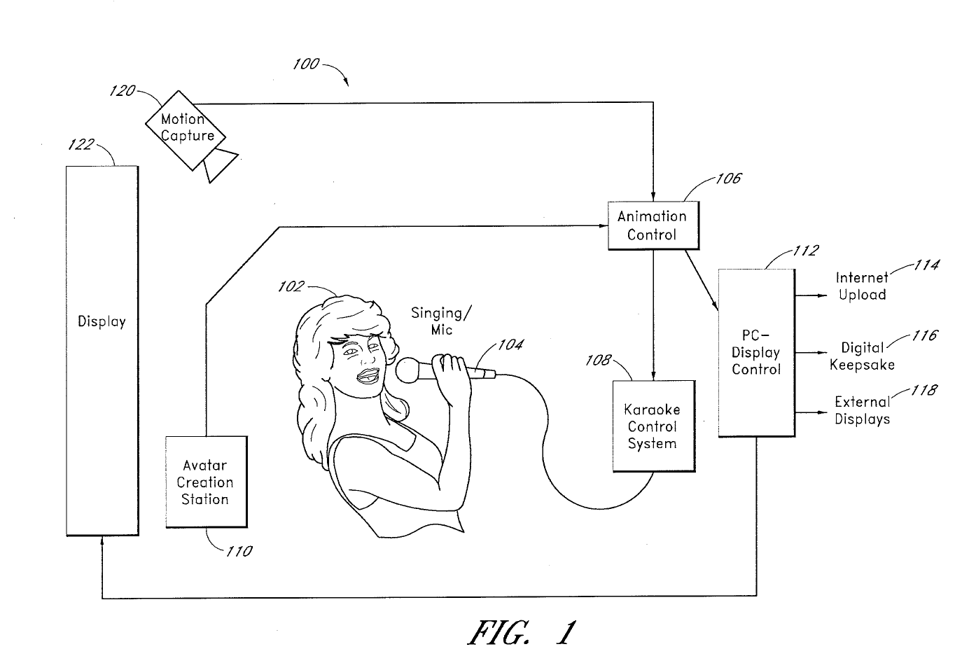

FIG. 1 is a diagram illustrating the components and flow of the avatar mapping system. The system 100 consists of a user 102, a microphone 104, an animation control system 106, a karaoke control system 108, an avatar creation system 110, a PC display control 112, an upload 114, digital keepsake 116, external displays 118, motion capture system 120 and display 122.

The system 100 is configured to receive user 102 input choices for the user's performance using the avatar creation station 110. The user 102 then engages in a performance for which the user's 102 voice and movements are captured by a karaoke control system 108 and a motion capturing system 120. The animation control module 106 receives input from the motion capturing system 120 and the karaoke control system 108 while mapping the voice and movements onto the avatar chosen by the user 102. The final mapped performance is routed through a PC display control 112 to one or more output displays such as an internet upload 114, a digital keepsake 116 or an external display 118, for instance, a side of a building.

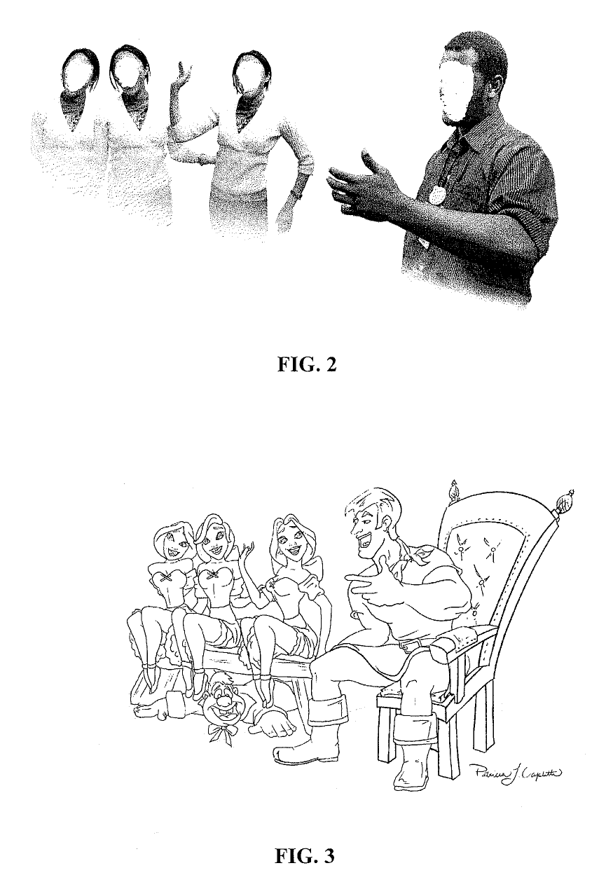

The various components of the system 100 are described in greater detail in the remaining FIGS. 2-7C.

FIG. 2 illustrates a group of users 102 in a performance. The performance comprises the users 201, 202, 203 and 204. Not shown in FIG. 2 is the recording equipment 108 which is recording the voice 108 and movements 120 of the users 201-204. In some embodiments, a recording is not retained, and the movements and voice are mapped to the avatar and displayed in real-time.

As described above, the system 100 is configured to store user 102 performances including voice and movements. In some embodiments, there is not appreciable movement by the user. In some embodiments, the user will dance or be otherwise animated. In other embodiments, the user expresses dramatic gestures but no appreciable body movement. In some embodiments, there is only one user. In the embodiment shown in FIG. 2, there are four users 102 performing simultaneously. In other embodiments, the users 102 may perform sequentially, and the performances will be combined during the animation control 106 or the PC display control 112 process.

FIG. 2 depicts an embodiment comprising four users 102 in the process of performing using motion and voice. The users 102 are shown in FIG. 2 in their actual form and also as they would be mapped to their respective chosen avatars in FIG. 3. The first user 201 has her arms completely down to her sides. The second user 202 has her arms downward but raised slightly at the elbows. The third user 203 has one of her arms raised in the upward direction from the elbow, and one arm is in the downward position. The fourth user 204 is slightly separated from the other three people and has one arm at chest length. The four users after having chosen their avatars, are mapped with regard to their voices and motions, and then overlaid onto their respective avatars.

Referring now to FIG. 3, which illustrates the mapping from FIG. 2 as 301, 302, 303 and 304 respectively of the users 102 listed above in FIG. 2. One or more of the avatars in each scene represent the character avatar chosen by the one or more users 102. As depicted, each avatar is mapped to perform the same motions and voice output as the respective actual user. In some embodiments the avatar interacts with characters not representing other users 102 but who are characters in a movie or other animation chosen by the users 102, for instance, characters in a movie auxiliary to the user's character.

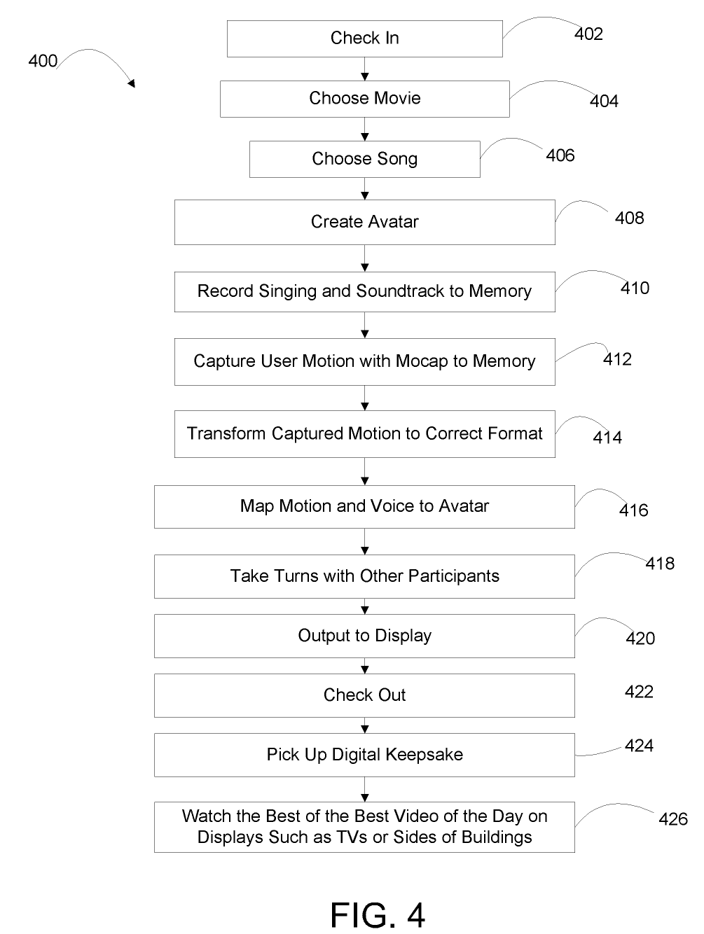

FIG. 4 is a flowchart illustrating an example of a method for mapping a user's 102 voice and motions onto an avatar. FIG. 4 includes a check-in 402, choose movie 404, choose song 406, create avatar 408, record singing and soundtrack to memory 410, capture user motion with motion capture software to memory 412, transform captured motion to correct format 414, map motion and voice to avatar 416, take turns with other participants 418, output to display 420, check out 422, pickup digital keepsake 424, and watch the best of the best video of the day on displays such as TVs or sides of buildings 426.

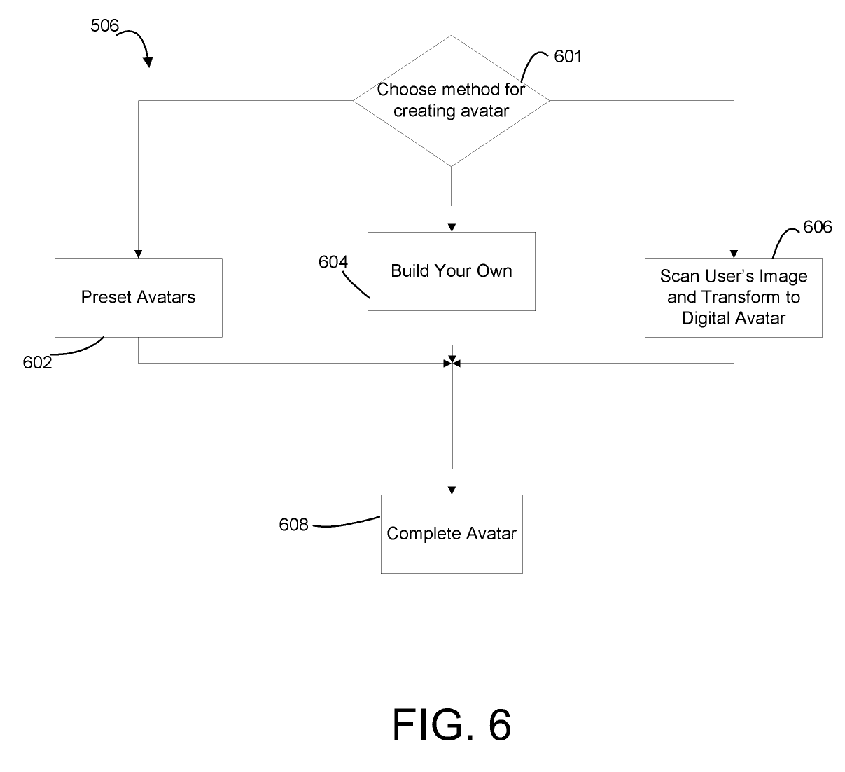

Beginning with the check-in 402, a user checks in with the system administrator. The system administrator can be a front desk clerk or some other person or automated system or kiosk in charge of the process. The user 102 then chooses a movie or other animation or combination thereof 404. The user 102 will then choose a song 406 for his or her performance backdrop. Once the movie and song are chosen, the user 102 will choose an avatar to represent him. The choice of avatar is described in greater detail in FIG. 6, below. Advancing to the step after choosing an avatar, the user 102 then records singing and soundtrack information to memory 410. Motion capturing software will record the user's motions 412. Moving to block 414, the system will transform the captured motion to the correct format and then software will map motion and voice to the avatar 416. In one embodiment, several users take turns 418 performing for the same final performance. The combined voice and motion are output to a display 420. After the performance is complete the user checks out 422 and may pick up a digital keepsake 424. A best of the best performance can take place, displayed on a wall or side of a building 426 or on digital posters at predetermined locations. In some embodiments, performances can be uploaded to the internet, for instance, You Tube®, for viewing from anywhere with access to the internet. In some embodiments, the performances can come from all over the world. In other embodiments, the performances are local to a location or event.

During the check-in process 402, the users 102 are signed in and presented with options for their user preferences. Moving to choose movie 404, the user 102 is presented with choices of scenes from a movie or animation. In some embodiments, a movie will not be chosen and a simple background will suffice. In some embodiments, there is one user 102, but in other embodiments there is more than one user 102. The system is configured to accept numbers of users 102 to correspond with any number of the characters in the chosen movie or animation scene but can be expanded upon to include more characters that are similar in branding to the chosen movie or animation.

Once the movie selection 404 is completed, the user 102 will choose a song from the chosen movie or animation scene 404. In some embodiments, if the user 102 does not choose a movie 404, the user can choose any song 406 because there is no direct coordination that needs to take place between scenery and music or characters.

After the song is chosen 406, the user 102 will create the avatar 408 that will be later mapped with their performance. The user 102 has many options for creating the avatar. The create avatar 408 module is configured to give the user 102 the choice of at least choosing an avatar originating or known from the user's 102 chosen movie or animation scene 404, creating a digital scanned image of the user 102 or building an avatar from a generic template that can be refined to the user's 102 specifications. These options are described in more detail in FIG. 6.

Advancing to recording the user's 102 voice and soundtrack to memory, the user will perform the song, in some embodiments the performance is karaoke style, of the song 406 chosen earlier. In some embodiments, the user 102 will perform alone. In other embodiments, the user 102 will perform as part of a group following typical karaoke styling.

While the user 102 is performing, the motion capture system 120 is capturing and recording 412 the user's 102 motions while the user 102 performs. In some embodiments the user performs alone. In other embodiments, the user performs with others who signed up for same performance.

The motion capture module 412 records the user's motions 412, for example dancing or using gestures and facial expressions. Motion capturing is also referred to as motion tracking or mocap. In instances where the mapping includes face, fingers and captures subtle expressions, it can also be referred to as performance capture. In motion capture sessions, movements of one or more actors or users 102 are sampled many times per second, although with most techniques (recent developments from ILM use images for 2D motion capture and project into 3D) motion capture records only the movements of the actor or user, and not his/her visual appearance. This animation data is mapped onto a 3D model so that the model performs the same actions as the actors or users who performed them. This is comparable to the older technique of rotoscope where the visual appearance of an actor was filmed, then the film was used as a guide/template for the frame by frame motions of a hand-drawn animated character.

Camera movements can also be reproduced physically or virtually so that when a camera moves in a movie or animation scene, such as pan, tilt, or dolly around the stage driven by a camera operator, the actor or user's performance and usage of props will be recorded by the motion capture camera and mimicked in the virtual space. This allows the computer generated characters, images and sets, to have the same perspective as the video images from the camera. A computer processes the data and displays the movements of the actor or user 102, providing the desired camera positions in terms of objects in the set. Retroactively obtaining physical camera movement data from the captured footage is known as match moving.

There are advantages of motion capture over computer animation. Motion capture offers several advantages over traditional computer animation of a 3D model including more rapid, even real time results, reduction of the costs of rendered keyframe-based animation (i.e. Hand Over), the amount of work does not vary with the complexity or length of the performance to the same degree when using traditional techniques. This allows many tests to be done with different styles or deliveries. Complex movements and realistic physical interactions such as secondary motions, weight and exchange of forces can be easily recreated in a physically accurate manner as opposed to rendered simulation.

At 414, the block titled “Transform captured motion to correct format,” the captured and recorded voice and movements are mapped to the chosen avatar 408 and movie or animation scene 404. The final performance of 414 is output to the display 420. In one embodiment, the display 420 is a video screen.

Advancing to 420, the user's check out, check-out 420 brings the performance experience to a close and may involve payment or some other action that signals the conclusion of the performance or transaction. In one embodiment, the users 102 will receive digital keepsake 424. A digital keepsake is analogous to the greeting cards that play a song when opened. In some embodiments, the digital keepsake 424 is a digital still from the performance that plays the vocal performance 410 when the keepsake 424 is opened. In another embodiment of the digital keepsake, the digital keepsake 424 actually plays a video clip of all or some of the performance as opposed to a still photo.

In yet another embodiment, the display may be output to an external or remote display such as on the side of building onto which the image is projected or onto a digital billboard/poster. In some embodiments, there is a contest between performances on which observers can vote for the best. In other embodiments, performances are shown in almost real-time. In other embodiments, performances are recorded and shown at a later time.

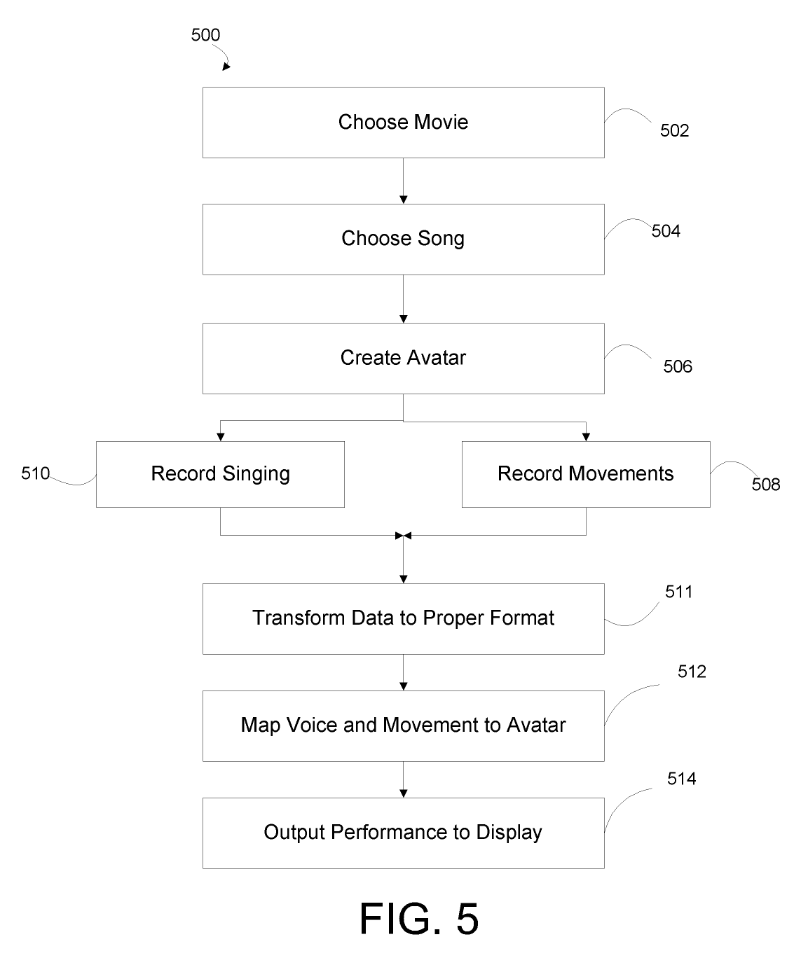

FIG. 5 illustrates a higher level flowchart for the avatar mapping system including choosing a movie 502, choosing a song 504, creating an avatar 506, recording singing 510, recording moments 508, transforming the recorded data to the proper format 511, mapping the voice and movement recordings to the chosen avatar 512, and outputting the performance to display 514.

In one embodiment a user 102 can choose an animation, for instance a movie 502. In other embodiments, the movie is a combination of animation and regular film. After the movie is chosen, the user 102 chooses a song 504. In some embodiments the song 504 is a song from the movie soundtrack. In other embodiments, the song is from a larger library. After choosing the song, the user must create an avatar 506. In some embodiments, the user will choose a character from the user's chosen movie or animation as the user's avatar. Other methods of using an avatar 506 are described below in conjunction with FIG. 6.

After the user chooses the movie, song and avatar, the user's singing and movements are recorded. In some embodiments, there are several users representing avatars from the same movie who are doing their performance together. In this type of embodiment, the users can record their singing and movement parts concurrently. In other embodiments, the users will take separate turns recording the singing and movements for their individual performance.

The system then converts the recorded data into the proper output. The animation software will also combine the performances into one recording for the mapped final result if necessary. The voices and movement are mapped onto the respective avatar and then the performance is output to a display. In one embodiment, the performance can be mapped and displayed in practical real-time, including live broadcast format of the user's voice. In other embodiments, the performance is recorded and displayed at a later time.

FIG. 6 illustrates greater detail of FIG. 5 element 506, which is shown in this FIG. 6 as element 600, and includes the steps of choosing a method for creating avatar 601, preset avatars 602, building your own avatar 604, scanning the user's image 606 and the completed avatar 608. The system is configured so that each user 102 may choose the user's 102 avatar based on options including choosing an avatar from a preset avatar 602, configuring an avatar 604, or scanning the user's 102 image and then transform that image to a digital avatar 606 representation of the user 102. Once the avatar is selected from a pre-existing list or else formed from other selection criteria, the step of choosing an avatar 601 is complete 608.

Each user 102 is able to choose a method of creating his or her avatar. Choosing an avatar 601 gives a user the choice of choosing from a preset avatar 602. These preset avatars can include characters from the chosen movie or else avatars previously chosen and stored in the system as having been an avatar choice available to other users. A preset avatar is already in the system and is ready to be used or selected again. In some embodiments, this character is an actual character from a movie or animation. In other embodiments, the avatar is an avatar used in other presentation media besides movies. In still other embodiments, the avatar is a character from a comic book or video game.

The second choice presented to the user is to build a personalized or stylized avatar 604. In this option, the user 102 has choices for virtually all the components of the avatar. In some embodiments the user has access to options, for instance, a database or similar collections of at least one option for each of a defined set of features and options with the goal being that the finished avatar will be as real to the user 102 as the user 102 desires.

For the final option, the user's 102 image can be digitally scanned 606 and transformed into an avatar. This process utilizes software such as, for instance, Optitex, often used in the fashion industry to create 3-D forms or Alvanon, software which can scan a human form to a computer memory.

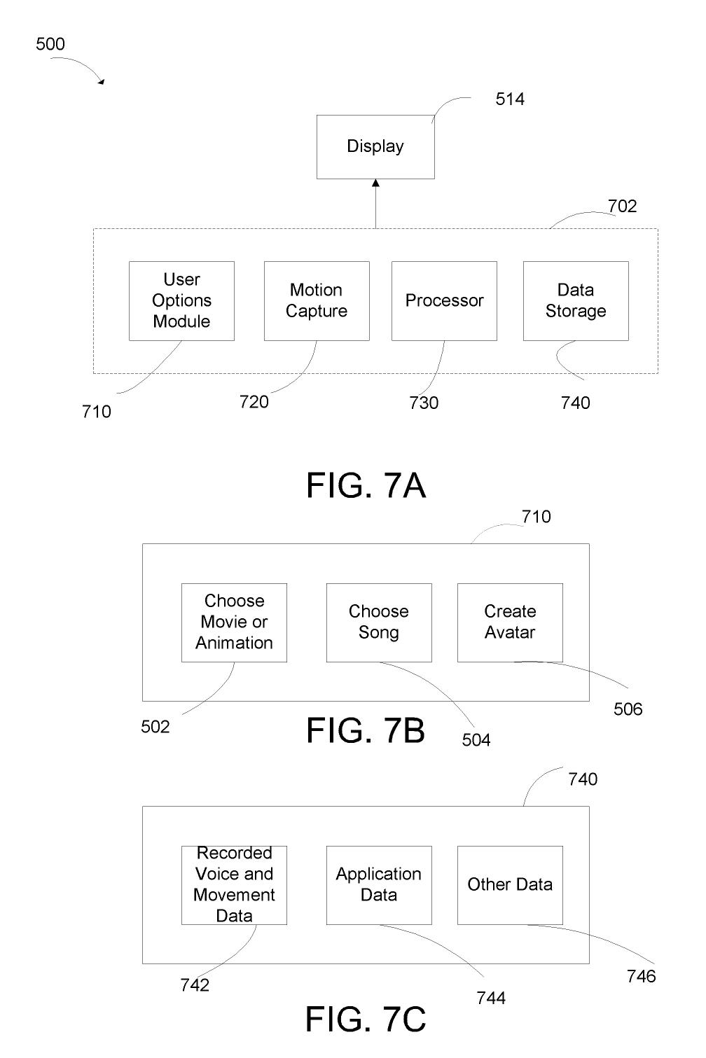

Referring now to FIG. 7A which is a diagram illustrating an example system 500 for avatar mapping. FIG. 7A illustrates a system view, including a display 514, system processing unit 702. The system processing unit comprises a user options module 710, motion capture module 720, a processor module 730 and a data storage module 740. The user options module 710, motion capture module 720, processor module 730 and data storage module 740 are not necessarily in the same physical unit. The user options module 710 is configured to receive the user's choices with regard to a movie or animation, a song and an avatar. The user options module is described in greater detail in FIG. 7B.

After the users' voice and motion are captured, the processing module 730 maps the motion and voice of the user to the avatar. The processor 730 may also be referred to as a core. Although one processor 730 is illustrated in FIG. 7A, the avatar mapping system 500 may include a greater number of processors. The system processing unit 702 and/or the processor 730 is in communication with the display device 514.

The data storage module provides memory for use with the processor and motion capture software. The final performance of the system processing unit 702 is output to the display 514. In one embodiment, the display 514 is a video screen. In another embodiment, the display is a digital keepsake. In yet another embodiment, the output is a remote display onto which the image is projected/played.

The avatar mapping system 500 may further include a memory and storage 740 in communication with the processor 730. Data storage and memory 740 may comprise volatile memory which in turn comprises certain types of random access memory (RAM) such as dynamic random access memory (DRAM) or static random access memory (SRAM), or may comprise any other type of volatile memory. The volatile memory may be used to store data and/or instructions during operation of the processor 730. Those skilled in the art will recognize other types of volatile memory and uses thereof

The avatar mapping system 500 may further include a non-volatile memory in communication with the processor 730. The non-volatile memory may include flash memory, magnetic storage devices, hard disks, or read-only memory (ROM) such as erasable programmable read-only memory (EPROM), or any other type of non-volatile memory. The non-volatile memory may be used to store programs, images, instructions, character information, program status information, or any other information that is to be retained if power to the system 500 is removed. The system 500 may comprise an interface to install or temporarily locate additional non-volatile memory. In some embodiments, a hub will contain copies of performances from remote memory sources for access from other sites so that a user 102 may access his saved character over and over or at more than one location. Those skilled in the art will recognize other types of non-volatile memory and uses thereof.

The system 500 is not limited to the devices, configurations, and functionalities described above. For example, although a single memory 740 and processor 730 are illustrated, a plurality of any of these devices may be implemented internal or external to the system 500. In addition, the system 500 may comprise a power supply or a network access device or disc drive. Those skilled in the art will recognize other such configurations of the system 500.

FIG. 7B depicts the first steps of the process 710, comprising choose movie or animation 502, choose song 504, and create avatar 506. The user 102 first chooses a movie or animation 502. By choosing a movie or animation, the user will have access to relevant or applicable songs to perform. Next, the user 102 will choose a song relating to the movie or animation with the idea that the avatar chosen to represent him will perform this song. Lastly, the user will select an avatar to represent him in the virtual space. These processes are described in greater detail in previous figures.

Graphics and animations for display by the system for creating avatars 500 can be accomplished using any number of methods and devices. Three dimensional software, such as, for example, Maya, originally developed by Alias Systems Corporation but now owned by Autodesk, is often used, especially when generating graphics and animations representing a 3D modeled environment. Using such software, an animator can create objects and motions for the objects that can be used by the engine of the system 500 to provide data for display on the display device 514.

FIG. 7C illustrates greater detail of the data storage 740, comprising recorded voice and movement data 742, application data 744, and other data 746. At module 742, the user has recorded the voice and movement. Application data 744 is stored representing the recorded voice and movement data as well as software application data and the mapped voice and movement data to the avatar. Other data 746 is also stored as needed by the application data 744.

In some embodiments, the system uses a professional recording studio. In other embodiments any camera or other recording device that captures the input, for example the user's voice and movements, can be used. In some embodiments, the sound is played live, instead of recorded, with the mapped performance through the use of a public address or similar system.

### Variations of Embodiments

In some embodiments a user will perform alone. In other embodiments a group of users perform one at a time; and in still another embodiment, the performance will be made up of several users performing in turn and then mapped and joined together by the system in the final output. The final performance is displayed or otherwise output by the method of the user's choosing.

In yet another embodiment, the users of the same intended final performance are at different locations; however their performances are combined into one final performance. In some embodiments, one user can make multiple recordings as different avatars in the movie or animation and then have the recordings combined into one ensemble final performance.

In some embodiments, the entire process is part of the show for an audience. For example, in such an embodiment, an audience or group of observers sees the user or users performing the song or skit from the chosen movie or animation. The system software converts and maps the performance attributes such as voice and movement to the chosen avatar and then outputs the final performance to a display. In some embodiments, an audience or group of observers can view only the final, mapped performance, as this preserves the anonymous participation aspect for the user while sampling the fun of performing.

In some embodiments, performances are taking place in a variety of places. For instance, at different locations in a theme park or different locations within a school or other institution, or even in different locations worldwide. The performances are shown on a display in multiple locations. In some embodiments observers and users can vote for the best one or other designations as desired.

While the above detailed description has shown, described, and pointed out novel features of the disclosure as applied to various embodiments, it will be understood that various omissions, substitutions, and changes in the form and details of the device or process illustrated may be made by those skilled in the art without departing from the spirit of the disclosure. As will be recognized, the present disclosure may be embodied within a form that does not provide all of the features and benefits set forth herein, as some features may be used or practiced separately from others. The scope of the disclosure is indicated by the appended claims rather than by the foregoing description. All changes which come within the meaning and range of equivalency of the claims are to be embraced within their scope.

What is claimed is:

1. A method for creating and controlling an avatar in a virtual space, the virtual space accessed through a computer network executing a computer program, the method comprising:
identifying an animation or movie from a predetermined list;
identifying a song or scene from the movie or animation;
creating an avatar;
capturing a user's live voice recording in a data storage;
capturing the user's live movements to the data storage;
translating the captured movements to a particular format;
mapping the user's movements to the avatar;
mapping the user's corresponding recorded voice recording to correspond with the animated avatar; and
displaying the animated avatar with sound,
wherein the capturing, processing and mapping are continuously performed as to correlate the movements of the user with the displayed avatar.

2. The method of claim 1, wherein creating an avatar comprises selecting a character from the animation or movie.

3. The method of claim 1, wherein creating an avatar comprises creating a digital representation of the user.

4. The method of claim 1, wherein creating an avatar comprises selecting a predefined avatar and altering the features of the avatar according to user input.

5. The method of claim 1, wherein displaying the avatar is displaying on one of: a television, a digital keepsake, a movie screen, and the Internet.

6. The method of claim 1, wherein mapping the user's movements to the avatar is done proportional in acceleration and deceleration to the rotational and translational movements of the user.

7. The method of claim 1, wherein portions of the avatar include specific animated body parts.

8. The method of claim 1, wherein the list of avatars are representative to the selected movie or animation.

9. The method of claim 1, wherein the avatar is animated in a virtual space wherein the virtual space comprises scenes from a movie or animation.

10. A method for user interaction with animated characters, the method comprising:
creating an avatar from a list of avatars;
mapping the user's voice and movements to the voice and movements of the avatar; and
outputting the avatar's movement and voice,
wherein the user is represented by an avatar.

11. The method of claim 10, wherein the avatar is animated in a virtual world.

12. The method of claim 10, further comprising capturing the voice and movement of the user to video.

13. The method of claim 10, wherein the outputting the avatar's movement and voice comprises:
displaying the avatars of all of the users in a performance,
displaying at least one performance,
wherein the displaying can take place over a period of time and can be remote from the live performance such that users in different locations can view performances and vote on their favorites.

14. A method for interactively controlling the voice and motions of at least one avatar through a computer network, the method comprising:
capturing input, the input comprising:
the movements of the at least one user; and
the voice of the at least one user;
processing the input;
wherein processing the input comprises mapping the voice and movement of the at least one user to the animated motion of the corresponding avatar, and
wherein the capturing, processing and mapping are continuously performed so as to correlate between relative motion of the at least one user and the corresponding avatar.

15. A system for creating and controlling an avatar in a virtual space, the system comprising:
an animation or movie identified by a user from a predetermined list;
a song or scene from the movie or animation;
an avatar;
voice recording means;
a data storage;
motion capturing means;
translation means for translating the captured movements to a particular format;
mapping means for mapping the captured movements and recorded voice to the avatar;
a final performance in which the captured movements and recorded voice are mapped to the avatar;
a display configured for sound;
a computer processor for executing a computer program to access the virtual space; and
wherein the capturing, processing and mapping are continuously performed so as correlate the movements of the user to the displayed avatar.

16. The system of claim 15, wherein the avatar is selected from a list.

17. The system of claim 16, wherein the list of avatars are representative to the identified movie or animation.

18. The system of claim 15, wherein the avatar is a digital representation of the user.

19. The system of claim 15, wherein the avatar is a predefined avatar altered according to user input.

20. The system of claim 15, wherein the avatar is animated in a virtual space wherein the virtual space comprises scenes from the movie or animation.

21. The system of claim 15, wherein the motion capturing means capture and record a live user's movements to the data storage.

22. A system for interaction with animated characters, the system comprising:
an avatar created from a list;
mapping means for mapping movements to the avatar;
mapping means for mapping a voice to the avatar; and
a display configured for sound for outputting a final performance,
wherein a user of the system is represented by the avatar.
